(19) United States
(12) Patent Application Publication
(10) Pub. No.: US 2025/0092557 A1
(43) Pub. Date: Mar. 20, 2025

(54) COATING PROTECTION FOR STATOR VANES AND METHODS OF PROTECTION THEREOF

(71) Applicant: RTX Corporation, Farmington, CT (US)

(72) Inventors: Lei Jin, Unionville, CT (US); Ryan Matthew Brodeur, Southwick, MA (US)

(21) Appl. No.: 18/826,313

(22) Filed: Sep. 6, 2024

Related U.S. Application Data
(60) Provisional application No. 63/583,048, filed on Sep. 15, 2023.

(51) Int. Cl. C25D 11/04; C22C 21/14; C22C 21/16; C22C 21/18

(52) U.S. Cl. CPC C25D 11/04; C22C 21/14; C22C 21/16; C22C 21/18

(57) ABSTRACT

An aluminum containing component comprises an aluminum alloy and an aluminum oxide layer disposed on the aluminum alloy. The aluminum oxide layer comprises crystalline aluminum oxide. The aluminum containing component is at least one of vane, a fan blade or a fan casing of a low pressure compressor section of a gas turbine. In an embodiment, a method comprises disposing an aluminum containing component in an electrochemical cell that comprises a dilute alkaline solution. The aluminum containing component is electrically contacted to become a first electrode in the electrochemical cell. The wall of the bath is electrically contacted to act as a second electrode in the electrochemical cell. A voltage is applied between the first electrode and the second electrode to form an aluminum oxide layer on the aluminum containing component.

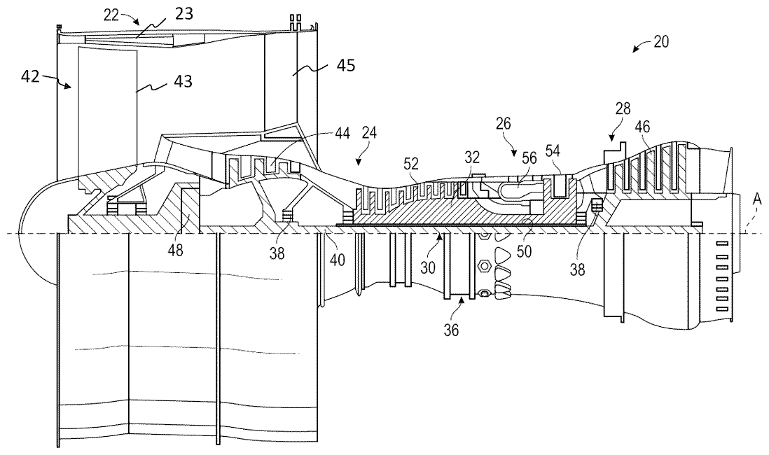

### CROSS-REFERENCE TO RELATED APPLICATIONS

This application claims the benefit of U.S. Application No. 63/583,048 filed Sep. 15, 2023, the disclosure of which is incorporated herein by reference in its entirety.

### BACKGROUND

This disclosure relates to a coating protection for stator vanes and to methods of protection of the stator vanes.

Aluminum low pressure-compressor (LPC) stator vanes are coated with a layer of porous amorphous aluminum oxide in an anodizing process. The layer of amorphous aluminum oxide is then protected by a hexavalent chromate seal. Chromate conversion coatings are formed by dipping the aluminum part (e.g., the aluminum low pressure-compressor (LPC) stator vanes) that has been anodized in chromic acid, to provide a coating comprising chromium oxide(s) mixed with aluminum oxide. Chromate conversion coatings are corrosion resistant, can be rapidly applied, undergo self-healing when scratched and are relatively inexpensive.

While anodized aluminum coatings (containing the amorphous aluminum oxide) with the chromate seal display effective corrosion resistance under normal neutral environmental conditions, they are very reactive under acidic or alkaline conditions and begin to deteriorate. Acidic environmental pollution attacks the anodized aluminum coating, leading to heavy corrosion due to intergranular attacks (IGA). The anodized aluminum coating (subjected to acid or alkaline environments) also has poor erosion resistance and it has been seen that the coating is often worn off, leaving exposed metallic aluminum parts, which can then undergo corrosion too.

To overcome this challenge, it is desirable to have better aluminum oxide coatings in the next generation of aluminum products.

### SUMMARY

In an embodiment, an aluminum containing component comprises an aluminum alloy and an aluminum oxide layer disposed on the aluminum alloy. The aluminum oxide layer comprises crystalline aluminum oxide. The aluminum containing component is at least one of vane, a fan blade or a fan casing of a fan section and a low pressure compressor of a gas turbine.

In another embodiment, the aluminum containing component is a vane, a fan blade and a fan casing of a fan section and a low pressure compressor of a gas turbine.

In yet another embodiment, the aluminum alloy comprises a majority of aluminum with the remainder being silicon, manganese, magnesium, copper, iron, zinc chromium and titanium.

In yet another embodiment, the silicon, manganese, magnesium, copper, iron, zinc chromium and titanium are present independently in amounts of 0.1 to 10 wt %, with the remainder being aluminum.

In yet another embodiment, the aluminum is present in amounts of greater than 80 wt %, based on a total weight of the aluminum alloy.

In yet another embodiment, the aluminum is present in amounts of greater than 85 wt %, based on a total weight of the aluminum alloy.

In yet another embodiment, silicon, manganese, magnesium, and copper are present independently from each other in amounts of in an amount of 0.1 to 7 wt %, based on total weight of the aluminum alloy.

In yet another embodiment, iron, zinc chromium and titanium are each independently present in amounts no greater than 0.5 wt %, based on total weight of the aluminum alloy.

In yet another embodiment, the aluminum is present in an amount of 90 to 96 wt %, based on a total weight of the aluminum alloy.

In yet another embodiment, the crystalline aluminum oxide comprises α-Al₂O₃ and γ-Al₂O₃ and has a hardness of greater than 600 HV.

In yet another embodiment, the aluminum alloy comprises an Al—Mn 3000 series alloy, an Al—Si 4000 series alloy, an Al—Mg 5000 series alloy, an Al—Mg—Si 6000 series alloy, an Al—Zn 7000 series alloy, or a combination thereof.

In yet another embodiment, the aluminum oxide layer has a thickness of 5 to 30 micrometers.

In yet another embodiment, the aluminum oxide layer comprises mesopores.

In an embodiment, a method of treating an aluminum containing component of a fan section and a low pressure compressor section of a gas turbine comprises disposing an aluminum containing component in an electrochemical cell that comprises a dilute alkaline solution. The aluminum containing component is electrically contacted to become a first electrode in the electrochemical cell. The wall of the bath is electrically contacted to act as a second electrode in the electrochemical cell. A voltage is applied between the first electrode and the second electrode to the electrochemical cell. An aluminum oxide layer is formed on the aluminum containing component.

In an embodiment, the dilute alkaline solution is a KOH solution.

In another embodiment, the voltage between the first electrode and the second electrode is greater than 200 V.

In yet another embodiment, the voltage between the first electrode and the second electrode is greater than 500 V.

In yet another embodiment, the oxide layer is 5 to 30 micrometers thick.

In yet another embodiment, the aluminum containing component comprises an aluminum alloy, where the aluminum alloy comprises an Al—Mn 3000 series alloy, an Al—Si 4000 series alloy, an Al—Mg 5000 series alloy, an Al—Mg—Si 6000 series alloy, an Al—Zn 7000 series alloy, or a combination thereof.

In yet another embodiment, the aluminum oxide layer is a crystalline aluminum oxide that comprises α-Al₂O₃ and γ-Al₂O₃ and has a hardness of greater than 600 HV.

### BRIEF DESCRIPTION OF THE FIGURES

The FIGURE schematically illustrates a gas turbine engine.

### DETAILED DESCRIPTION

Disclosed herein is a method of treating aluminum containing components such as aluminum containing components (at least one of blades, vanes (e.g., low pressure compressor vanes or structural guide vanes), or fan casing) present in the fan section and LPC (low pressure compressor) section of the engine. The method comprises subjecting aluminum containing components of a geared turbofan to a plasma electrolytic oxidation (PEO) process and then coating the crystallized ceramic protective coating (crystalline aluminum oxide) formed therefrom with a crosslinked polymer coating or with a trivalent or hexavalent chromate. The polymer coating seals the crystallized ceramic protective coating. In an embodiment, all of the blades, vanes and fan casing in the fan section and low pressure-compressor section of a geared turbofan contain a surface coating of crystalline aluminum oxide that is obtained by subjecting these aluminum containing components to a PEO process.

The FIGURE schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. The inner shaft 40 and the outer shaft 50 are concentric and rotate about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 54, 46 rotationally drive the respective low speed spool 30 and high speed spool 32 in response to the expansion.

With reference again to the FIGURE, the method of treating aluminum containing components using PEO may be applied to some of the components of the fan section 22 and the low pressure compressor section 44. These include the fan case 23, fan blade 43, structural guide vanes 45 and LPC stator vanes 44.

Aluminum anodization is an electrolytic passivation process used to increase the thickness of the natural oxide layer on the surface of the aluminum containing component. The process is called anodizing because the part to be treated forms the anode electrode of an electrolytic cell.

Conventional anodizing increases resistance to corrosion and wear and provides better adhesion for paint primers and glues than bare metal does. The anodizing process involves immersing the aluminum containing component into an acid electrolyte bath and passing an electric current through the medium. The acid action is balanced with the oxidation rate to form an aluminum oxide (which is mostly amorphous) coating with nanopores, 10-150 nm in diameter. The anodizing current varies with the area of aluminum being anodized and typically ranges from 30 to 300 A/m². As noted above, conventional aluminum anodization has a number of drawbacks, prominent amongst which is the fact that the aluminum oxide deteriorates in the presence of acidic and alkaline environments. This deficiency is overcome by using a plasma electrolytic oxidation (PEO) process.

Plasma electrolytic oxidation (PEO), also known as electrolytic plasma oxidation (EPO) or microarc oxidation (MAO), is an electrochemical surface treatment process for generating oxide coatings on metals such as aluminum, magnesium, and titanium. It is similar to anodizing, but it employs higher potentials, so that discharges occur and the resulting plasma modifies the structure of the oxide layer. This process can be used to grow thick (tens or hundreds of micrometers), largely crystalline, oxide coatings on the aluminum containing component. Because they can present high hardness and a continuous barrier, these crystalline, oxide coatings can offer protection against wear, corrosion or heat as well as electrical insulation.

The PEO process involves immersing the part (e.g., the aluminum containing component) to be coated in a bath of electrolyte which usually consists of a dilute alkaline solution such as KOH. The aluminum containing component is electrically connected to become one of the electrodes in the electrochemical cell, with the other “counter-electrode” typically being made from an inert material such as stainless steel and often consisting of the wall of the bath itself. Potentials of over 200 volts (V), preferably over 300 V and more preferably over 500 V are applied between these two electrodes. These may be continuous or pulsed direct current (DC) (in which case the aluminum containing component is simply an anode in DC operation), or alternating pulses (alternating current or “pulsed bi-polar” operation) where the stainless steel counter electrode might be earthed. The process can be used to grow thick (tens or hundreds of micrometers), largely crystalline, oxide coatings on the aluminum containing part. This process may be used on pure metals such as aluminum, magnesium, titanium, or alloys thereof.

In an embodiment, the method comprises disposing the aluminum containing component in an electrochemical cell that comprises a dilute alkaline solution. Examples of the dilute alkaline solution include KOH, NaOH, sodium silicate, sodium phosphate, or a combination thereof. The aluminum containing component is electrically contacted to become a first electrode in the electrochemical cell, while the wall of the bath acts as the second electrode in the electrochemical cell. A voltage between the first electrode and the second electrode of greater than 200 V, preferably greater than 500 Vis applied to the electrochemical cell. An aluminum oxide layer is formed on the aluminum containing component.

The PEO process results in localized plasma reactions with conditions of high temperature and pressure which modify the growing oxide. Processes include melting, melt-flow, re-solidification, sintering and densification of the growing oxide.

In the case of aluminum metal or aluminum containing components (which may be aluminum alloys), one of the advantageous effects is that the oxide is partially converted from amorphous alumina into crystalline forms such as corundum (α-Al₂O₃) which is much harder than the amorphous alumina. As a result, mechanical properties such as wear resistance and toughness are enhanced over than of aluminum that is anodized using conventional anodization.

In an embodiment, the crystalline aluminum oxide formed on the aluminum containing component contains α-Al₂O₃ and γ-Al₂O₃ and has a hardness of greater than 600 HV (Vicker's Hardness), preferably greater than 1000 HV, and more preferably greater than 1200 HV.

In an embodiment, the aluminum containing component may contain pure aluminum metal or an aluminum alloy. Pure aluminum generally contains aluminum in an amount of greater than 99 wt %, preferably greater than 99.5 wt %.

In an embodiment, of the aluminum alloy comprises a majority of aluminum with the remainder being silicon, manganese, magnesium, copper, iron, zinc chromium and titanium.

In an embodiment, each of the silicon, manganese, magnesium, copper, iron, zinc chromium and titanium are present independently in amounts of 0.1 to 10 wt %, with the remainder being aluminum. The aluminum is generally present in amounts of greater than 80 wt %, preferably greater than 85 wt %, based on a total weight of the aluminum alloy.

The aluminum alloy may comprise silicon, manganese, magnesium, copper, that vary independently from each other in amounts of in an amount of 0.1 to 7 wt %, preferably 0.3 to 5 wt %, preferably 0.5 to 2 wt %, based on total weight of the aluminum alloy. Other metallic elements that may be present in the aluminum alloy are iron, zinc chromium and titanium each present independently in amounts no greater than 0.5 wt %, based on total weight of the aluminum alloy. The remainder is of the alloy is the aluminum. Examples of a few aluminum alloys are provided below.

In one embodiment, the aluminum containing component generally comprises an aluminum alloy that contains an amount of aluminum greater than 85 weight percent (wt %), preferably greater than 90 wt %, based on a total weight of the aluminum alloy. The aluminum alloy can be present in an amount of up to 96 wt %, based on the total weight of the aluminum alloy. The aluminum containing alloy may also contain copper in an amount of 3.0 to 5.0 wt %, manganese in an amount of 0.2 to 1.2 wt %, magnesium in an amount of 0.1 to 2 wt % and silicon in an amount of 0.1 to 1.5 wt %. Other metallic elements that may be present in the aluminum alloy are iron, zinc chromium and titanium each in amounts no greater than 0.3 wt %. Examples of aluminum alloys that may be used in the aluminum containing component include Al 2024 and Al 2014 (from the Al—Cu 2000 series).

In another embodiment, the aluminum containing component generally comprises an aluminum alloy that contains an amount of aluminum greater than 85 weight percent (wt %), preferably greater than 90 wt %, based on a total weight of the aluminum alloy. The aluminum alloy can be present in an amount of up to 94 wt %, based on the total weight of the aluminum alloy. The aluminum alloy can contain copper in an amount of 5.5 to 7.0 wt %. Other elements include iron in an amount of up to 0.3 wt %, manganese in an amount of 0.2 to 0.4 wt %, silicon in an amount of up to 0.2 wt %, titanium in an amount of 0.02 to 0.1 wt % and vanadium in an amount of 0.02 to 0.1 wt %, based on a total weight of the aluminum alloy. An example of such an alloy is Al 2219 (from the Al—Cu 2000 series).

Other examples of aluminum alloys that may be used in the aluminum containing components include aluminum alloys from the Al—Mn 3000 series, Al—Si 4000 series, Al—Mg 5000 series, Al—Mg—Si 6000 series, Al—Zn 7000 series, or a combination thereof.

The crystalline oxide formed on the surface of the aluminum containing component is dense with limited mesopores. The crystalline oxide formed on a surface of the aluminum containing component generally has a thickness of 5 to 30 micrometers, preferably 7 to 15 micrometers. The coating comprises mesopores (having an average pore diameter of 2 to 50 nanometers) and is very uniform.

In an embodiment, after the production of the crystalline coating on a surface of an aluminum containing component, the mesopores may be sealed with a polymer that may undergo crosslinking. Examples of crosslinked polymers include epoxides, phenolics, polyfluoroethylenes, polysiloxanes, or a combination thereof.

In an embodiment, the limited mesopores of the aluminum containing component manufactured via PEO can be sealed with trivalent or hexavalent chromates. Chromate conversion coatings are often applied to passivate aluminum. Chromate coatings are formed by the reaction of aqueous solutions of chromic acid or chromium salts. The coatings can be applied to aluminum, zinc, cadmium and magnesium. The coatings usually have good atmospheric corrosion resistance.

As noted above, the aluminum containing components with surfaces prepared by PEO and sealed with either a polymer or with trivalent or hexavalent chromates have minimized residual stresses which indicate a low fatigue debit of the coating.

The aluminum containing component detailed herein are exemplified by the following non-limiting examples.

### Example

This example was conducted to compare a conventional anodization with an anodization performed via PEO. Aluminum alloy samples (e.g., the aluminum containing components) of length 0.9 inches and width 0.7 inches were subjected to conventional anodization. Separate samples having the same dimensions and comprising the same aluminum alloy was subjected to anodization via PEO. Both samples were subjected to several erosion shots at an incidence angle of 20 degrees at a velocity of 500 feet per second. The erodent was AFRL02. AFRL 02 test dust comprises 34 wt % quartz, 30 wt % gypsum, 17 wt % aplite, 14 wt % dolomite and 5 wt % salt and is a standard commercially available erodent. The tests were conducted on each of the aluminum alloy samples at room temperature. The samples were not sealed with any sealant such as a polymer sealant or a chromate sealant.

The results of the erosion tests show that the aluminum alloy samples treated with a conventional anodization does not survive a single shot of erosion testing, while the aluminum alloy samples that were anodized via PEO survived at least 4 shots of erosion testing.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An aluminum containing component comprising:
an aluminum alloy; and
an aluminum oxide layer disposed on the aluminum alloy; where the aluminum oxide layer comprises crystalline aluminum oxide; where the aluminum containing component is at least one of vane, a fan blade or a fan casing of a fan section and a low pressure compressor section of a gas turbine.

2. The component of claim 1, where the aluminum containing component is a vane, a fan blade and a fan casing.

3. The component of claim 1, where the aluminum alloy comprises a majority of aluminum with the remainder being silicon, manganese, magnesium, copper, iron, zinc chromium and titanium.

4. The component of claim 3, where the silicon, manganese, magnesium, copper, iron, zinc chromium and titanium are present independently in amounts of 0.1 to 10 wt %, with the remainder being aluminum.

5. The component of claim 4, where the aluminum is present in amounts of greater than 80 wt %, based on a total weight of the aluminum alloy.

6. The component of claim 4, where the aluminum is present in amounts of greater than 85 wt %, based on a total weight of the aluminum alloy.

7. The component of claim 4, where silicon, manganese, magnesium, and copper are present independently from each other in amounts of in an amount of 0.1 to 7 wt %, based on total weight of the aluminum alloy.

8. The component of claim 4, where iron, zinc chromium and titanium are each independently present in amounts no greater than 0.5 wt %, based on total weight of the aluminum alloy.

9. The component of claim 4, where the aluminum is present in an amount of 90 to 96 wt %, based on a total weight of the aluminum alloy.

10. The component of claim 1, where the crystalline aluminum oxide comprises α-Al₂O₃ and γ-Al₂O₃ and has a hardness of greater than 600 HV.

11. The component of claim 1, where the aluminum alloy comprises an Al—Mn 3000 series alloy, an Al—Si 4000 series alloy, an Al—Mg 5000 series alloy, an Al—Mg—Si 6000 series alloy, an Al—Zn 7000 series alloy, or a combination thereof.

12. The component of claim 1, where the aluminum oxide layer has a thickness of 5 to 30 micrometers.

13. The component of claim 1, where the aluminum oxide layer comprises mesopores.

14. A method of treating an aluminum containing component of a fan section and a low pressure compressor section of a gas turbine comprising:
disposing the aluminum containing component in an electrochemical cell that comprises a dilute alkaline solution;
electrically contacting the aluminum containing component to become a first electrode in the electrochemical cell;
electrically contacting a wall of the bath to act as a second electrode in the electrochemical cell;
applying a voltage between the first electrode and the second electrode to the electrochemical cell; and
forming an aluminum oxide layer on the aluminum containing component.

15. The method of claim 14, where the dilute alkaline solution is a KOH solution.

16. The method of claim 14, where the voltage between the first electrode and the second electrode is greater than 200 V.

17. The method of claim 14, where the voltage between the first electrode and the second electrode is greater than 500 V.

18. The method of claim 14, where the oxide layer is 5 to 30 micrometers thick.

19. The method of claim 14, where the aluminum containing component comprises an aluminum alloy; where the aluminum alloy comprises an Al—Mn 3000 series alloy, an Al—Si 4000 series alloy, an Al—Mg 5000 series alloy, an Al—Mg—Si 6000 series alloy, an Al—Zn 7000 series alloy, or a combination thereof.

20. The method of claim 14, where the aluminum oxide layer is a crystalline aluminum oxide that comprises α-Al₂O₃ and γ-Al₂O₃ and has a hardness of greater than 600 HV.
